(19) United States
(12) Patent Application Publication
(10) Pub. No.: US 2024/0064819 A1
(43) Pub. Date: Feb. 22, 2024

(54) COMMUNICATION SYSTEM

(71) Applicant: NEC Corporation, Minato-ku, Tokyo (JP)

(72) Inventors: Maxime GRAU, Surrey (GB); Hisashi Futaki, Tokyo (JP)

(73) Assignee: NEC Corporation, Minato-ku, Tokyo (JP)

(21) Appl. No.: 18/270,815

(22) PCT Filed: Jan. 12, 2022
(86) PCT No.: PCT/JP2022/000683

§ 371 Date: Jul. 3, 2023

(30) Foreign Application Priority Data
Jan. 14, 2021 (GB) 2100488.2

(51) Int. Cl. H04W 74/08; H04W 74/04

(52) U.S. Cl. CPC H04W 74/0833; H04W 74/04

(57) ABSTRACT

A method performed by apparatus for providing access to a communication network is disclosed. The method includes transmitting to at least one user equipment (UE) system information including random-access configuration information for configuring the UE to perform random-access procedures. The random-access configuration information includes a plurality of different physical random-access channel (PRACH) preamble formats that can be applied by the UE in a random-access procedure. The apparatus receives, from the UE, signalling for initiating a random-access procedure, the signalling including a random-access preamble having a one of the plurality of different PRACH preamble formats and communicates with the UE to continue and complete the random-access procedure initiated by the UE.

### TECHNICAL FIELD

The present invention relates to a wireless communication system and devices thereof operating according to the 3rd Generation Partnership Project (3GPP) standards or equivalents or derivatives thereof. The disclosure has particular but not exclusive relevance to improvements relating to random-access procedures in the so-called ‘5G’ (or ‘Next Generation (NG)’ or ‘New Radio’ (NR)) systems for example random-access procedures for very large cells such as those that arise when NR is provided via Non-Terrestrial Networks (NTN).

### BACKGROUND ART

The latest developments of the 3GPP standards are the so-called ‘5G’ or ‘New Radio’ (NR) standards which refer to an evolving communication technology that is expected to support a variety of applications and services such as Machine Type Communications (MTC), Internet of Things (IoT)/Industrial Internet of Things (IIoT) communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

End-user communication devices are commonly referred to as User Equipment (UE) which may be operated by a human or include automated (MTC/IoT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 V16.3.0 and TS 37.340 V16.3.0 define the following nodes, amongst others:
gNB: node providing NR user plane and control plane protocol terminations towards the UE and connected via the NG interface to the 5G core network (5GC).
ng-eNB: node providing Evolved Universal Terrestrial Radio Access (E-UTRA) user plane and control plane protocol terminations towards the UE and connected via the NG interface to the 5GC.
En-gNB: node providing NR user plane and control plane protocol terminations towards the UE and acting as Secondary Node in E-UTRA-NR Dual Connectivity (EN-DC).
NG-RAN node: either a gNB or an ng-eNB.

3GPP is also working with the satellite communication industry to specify an integrated satellite and terrestrial network infrastructure in the context of 5G. This is referred to as Non-terrestrial networks (NTN) which term refers to networks, or segments of networks, using an airborne or spaceborne vehicle for transmission. Satellites refer to spaceborne vehicles in Low Earth Orbits (LEO), Medium Earth Orbits (MEO), Geostationary Earth Orbit (GEO) or in Highly Elliptical Orbits (HEO). Airborne vehicles refer to High Altitude Platforms (HAPs) encompassing Unmanned Aircraft Systems (UAS)—including tethered UAS, Lighter than Air UAS and Heavier than Air UAS—all operating quasi-stationary at an altitude typically between 8 and 50 km.

3GPP Technical Report (TR) 38.811 V15.4.0 is a study on New Radio to support such non-terrestrial networks. The study includes, amongst other things, NTN deployment scenarios and related system parameters (such as architecture, altitude, orbit etc.) and a description of adaptation of the 3GPP channel models for non-terrestrial networks (propagation conditions, mobility, etc.). Non-terrestrial networks are expected to:
help foster the 5G service roll out in un-served or underserved areas to upgrade the performance of terrestrial networks;
reinforce service reliability by providing service continuity for user equipment or for moving platforms (e.g. passenger vehicles-aircraft, ships, high speed trains, buses);
increase service availability everywhere; especially for critical communications, future railway/maritime/aeronautical communications; and
enable 5G network scalability through the provision of efficient multicast/broadcast resources for data delivery towards the network edges or even directly to the user equipment.

Non-Terrestrial Network access typically features the following elements (amongst others):
NTN Terminal: This may refer to the 3GPP UE or to a UE specific to the satellite system in the case that the satellite does not serve directly 3GPP UEs.
A service link which refers to the radio link between the user equipment and the space/airborne platform (which may be in addition to a radio link with a terrestrial based RAN).
A space or an airborne platform.
Gateways that connect the satellite or aerial access network to the core network. It will be appreciated that gateways will mostly likely be collocated with a base station (e.g. a gNB).
Feeder links which refer to the radio links between the Gateways and the space/airborne platform.

Satellite or aerial vehicles typically generate several beams over a given area. The beams have a typically elliptic footprint on the surface of the earth. The beam footprint may be moving over the earth with the satellite or the aerial vehicle motion on its orbit. Alternatively, the beam footprint may be earth fixed, in such case some beam pointing mechanisms (mechanical or electronic steering feature) may be used to compensate for the satellite or the aerial vehicle motion.

Once a UE has detected and selected a cell (and/or a beam in the case of 5G) it may attempt to access that cell and/or beam using an initial radio resource control (RRC) connection setup procedure including a random-access procedure that typically involves four distinct steps. In the case of 5G prior to attempting initial access the UE may perform transmission of a preamble to the network (e.g. a base station such as a gNB) over a physical random-access channel (PRACH) for initiating a process to obtaining synchronization in the uplink (UL). This step is often referred to as PRACH transmission or simply transmission of message 1 (Msg1). In response, the network responds with a random-access response (RAR) indicating reception of the preamble and providing a timing-alignment (TA) command for adjusting the transmission timing of the UE based on the timing of the received preamble. This step is often referred to as message 2 (Msg2) transmission. The UE then sends a third message (message 3 or ‘Msg3’) to the network over a physical uplink shared channel (PUSCH). The specific message sent by the UE in this step, and the content of the message, depends on the context in which the random-access procedure is being used. In the example of initial radio RRC connection setup, however, Msg3 includes an RRC Setup Request or similar message carrying a temporary randomly generated UE identifier. The network responds with a fourth message (message 4 or ‘Msg4’) which carries the randomly generated UE identifier received in Msg3 for contention purposes to resolve any collisions between different UEs using the same preamble sequence. When successful, Msg4 also transfers the UE to a connected state.

A similar random-access procedure may also be used in other contexts within NR including, for example, handover, connection reestablishment, requesting UL scheduling where no dedicated resource for a scheduling-request has been configured for the UE, etc.

As those skilled in the art will appreciate, while a contention based PRACH procedure is described, a non-contention based (or ‘contention free’) procedure may also be used in which a dedicated preamble is assigned by the base station to the UE.

In 5G NR there are currently 64 preambles defined for each time-frequency PRACH occasion. Each preamble transmission includes two parts—a cyclic prefix (CP) part and a preamble sequence part. The sequence part contains the preamble signature, which can be repeated (e.g. in preamble formats used for low signal-to-noise-ratio (SNR) situations). Since the UE may be located anywhere in a cell, and cell size can vary greatly, there is an inherent uncertainty in how long it will take for a given preamble transmission to be received. To allow for this uncertainty in preamble reception timing a guard period (GP) or ‘guard time (GT)’ is provided, following the preamble transmission, during which no signal is sent. The guard period is designed (together with the CP) to take into account maximum expected UL timing misalignment (i.e. based on the distance a UE might be from the base station when the UE is at the cell edge as represented by the cell radius). An UL timing misalignment that is greater than the maximum expected and thus falling outside the range provided for by the GP will cause the preamble to leak onto the next frame—this is referred to as preamble ambiguity.

A number of preamble formats are defined each preamble format being defined by a different respective CP+Sequence+GP set. There are currently a total 13 preamble formats defined for 5G for two different preamble types (‘short’ and ‘long’). There are 4 preamble formats (referred to as formats 0 through 3) defined for long preambles and 9 preamble formats (referred to as formats A1 to A3, B1 to B3, C0 and C2) defined for short preambles. FIG. 1 illustrates the 4 preamble formats for long preambles.

The different preamble sequences that can be used for the preambles are typically based on Constant Amplitude Zero Auto Correlation (CAZAC) sequences such as Zadoff-Chu sequences. The CAZAC sequence on which the preambles are based has a sequence length, L, in number of samples that is a prime number (839 for long preambles and 139 for short preambles) corresponding to as many orthogonal codes. For such prime-length sequences there are, therefore, L−1 (838 for long preambles and 138 for short preambles) different possible near orthogonal root sequences having low correlation (1/N839 for long sequences) between them that can be generated, each corresponding to a unique root index.

Different preamble sequences that are inherently orthogonal to one another can also be generated from different cyclic shifts of the same root index. However, this orthogonality is conditional on the cyclic shift between the different sequences being larger than the and differences between the respective timings at which they are transmitted. Any such UL timing misalignment will effectively cause a shift in the cycle (e.g. the UE sends sequence 100 but the base station interprets this as sequence 102 or 118). Accordingly, in some cases, only a reduced subset of possible cyclic shifts can be used to generate different preambles in dependency on the timing uncertainty (and hence cell size). Where all practically possible preamble sequences for a given root index become fully utilised, a different preamble sequence may need to be generated using a different root index.

The use of cyclic shifting allows preambles derived from a given root sequence to be divided between 1 to 64 groups (corresponding to the preamble signature) with the number of possible cyclic shifts depending on the maximum expected delay i.e. the cell radius as illustrated in Table 1 below:

TABLE 1

| | # of cyclic | | | Max cell radius |
|---|---|---|---|---|
| Sequence | shifts per ZC | # of ZC | Cyclic shift | from cyclic shift |
| length (μs) | seq. | sequences | (samples) | (km) |
| 800 | 64 | 1 | 13 | 0.78 |
| | 32 | 2 | 26 | 2.59 |
| | 16 | 4 | 53 | 6.34 |
| | 8 | 8 | 107 | 13.85 |

By way of example, considering the fourth row of Table 1, it can be seen that if preamble sequences derived from a given root index are fully utilised (e.g. divided into 8 for a cell of radius, r, where 6.34 km<r<13.85 km), then 7 other root indexes with low correlation must be used to achieve 64 preamble sequences.

UEs with no timing misalignment could, theoretically, use 839 preambles per sequence without the need for other root indexes to be used. This could be achieved when, for example: a UE has a recently stored TA value; a UE is at the cell centre (hence transmitting with no UL delay); or a UE has positioning capabilities and knowledge of base station location and can therefore calculate a TA value in advance and to apply it to compensate for the misalignment that would otherwise occur (this is referred to as pre-compensation).

The concept of zero-correlation zones (ZCZs) are used to account for the maximum expected delay/shift between one accepted sequence and the next. The base station can estimate the timing advance (TA) required for the TA command from this shift. The set of cyclic shifts that can be used within a cell are configured by the base station by means of a so-called zero-correlation zone parameter forming part of a random-access configuration provided by the base station in system information (e.g. in system information block type 1 (SIB1)).

The 838 root indexes are divided between neighbouring cells and may thus run out, ultimately limiting the number of available preambles in a given time/frequency resource.

The current theoretical cell size limitation is approximately a 100 km radius to allow for the maximum timing misalignment caused by UL delay for UEs at the cell edge (to a sequence length of 0.8 ms and maximum GP of 0.93 ms—i.e. preamble format 2 in FIG. 1·corresponds to the ultimate limitation). However, significantly bigger cells are expected in NTN (up to 1000 km radius) that may lead to higher differences in UL delay for different UEs' preambles on the RACH, depending on the altitude of the satellite and the maximum angle between the satellite and the cell centre.

The size of the cells negatively impacts random-access resources in multiple ways and this impact scales worse than quadratically with cell radius. Specifically, the number of UEs in a cell scales with the square of the radius (quadratic scaling). Preamble formats with a longer GP results in longer preamble sequences and thus fewer preambles per resource (linear scaling). Moreover, a long ZCZ arising from can lead to poor sequence utilization (typically one signature per root) which could lead to more interference between preambles because different root sequences are not perfectly orthogonal. Poor sequence utilisation also leads to root sequence overutilization leading to a progressive deterioration with cell size and representing a fundamental physical limitation.

In order to avoid the UL misalignment and preamble format issues that would result with providing NR over NTN, a UE is currently required to at least support UE specific TA calculation for pre-compensation based at least on a Global Navigation Satellite System (GNSS)-acquired position and knowledge of the serving satellite ephemeris. However, whilst an ability to determine a position is necessary to achieve TA pre-compensation, such a capability may not be sufficient, by itself, to do so. TA pre-compensation may, for example, not always be achievable (even with GNSS in case of e.g. lack of coverage) because many satellites (4+) are required for precise GNSS positioning. Furthermore, support for UEs without GNSS capability is not precluded for future releases of the standards.

The current random-access procedures have the potential to cause a number of issues that become particularly significant as cell sizes increase and/or the number of UEs operating in a cell increases significantly. These issues are particularly relevant to (but are not limited to) cells of NTNs.

The type of preamble used in the cell is currently configured as part of the cell random-access configuration and thus, within a given cell, only one type of preamble can be used for initial access. Traditional random-access resources are designed to accommodate for a worst-case scenario in which the UE is at the cell edge, potentially causing a bottleneck in a large and populated cell. In legacy cells, this one-size-fits-all approach may not have been a limiting problem because UEs were not expected to have pre-compensation capability (and the location of the base station was not known to the UE anyway), there were typically fewer UEs in a cell, and because the size of legacy cells was limited. However, this is no longer the case as cell size increases (especially for NTNs) and become more populated. Even in very large cells, UEs with precise timing advance pre-compensation can theoretically achieve 64 or more preambles per sequence root in a compact preamble format, which would lead to more efficient and available random-access resources for these UEs and the present one-size-fits-all approach lacks the flexibility to achieve this benefit.

### SUMMARY OF INVENTION

Accordingly, the present invention seeks to provide methods and associated apparatus that address or at least alleviate (at least one or more of) the above described issues.

Although for efficiency of understanding for those of skill in the art, the invention will be described in detail in the context of a 3GPP system (5G networks including NTN), the principles of the invention can be applied to other systems as well.

Example aspects of the invention are set out in the appended independent claims optional but beneficial features are set out in the appended dependent claims.

In one example aspect of the invention there is provided a method performed by apparatus for providing access to a communication network, the method including: transmitting to at least one user equipment (UE) system information including random-access configuration information for configuring the UE to perform random-access procedures, wherein the random-access configuration information includes a plurality of different physical random-access (PRACH) preamble formats that can be applied by the UE in a random-access procedure; receiving from the UE signalling for initiating a random-access procedure, the signalling including a random-access preamble having a one of the plurality of different PRACH preamble formats; and communicating with the UE to continue and complete the random-access procedure initiated by the UE.

In one example aspect of the invention there is provided a method performed by apparatus for providing access to a communication network, the method including: identifying that a user equipment (UE) served by the apparatus is to perform a contention-free random-access (CFRA) procedure; selecting, from a plurality of possible physical random-access channel (PRACH) preamble formats, a PRACH preamble format to be used by the UE in the CFRA procedure, wherein the PRACH preamble format is selected based on a PRACH preamble format previously used by the UE in a random-access procedure; signalling, to the UE, a random-access preamble to be used in the CFRA procedure based on the selected PRACH preamble format; receiving from the UE signalling for initiating the CFRA procedure, the signalling including the signalled random-access preamble; and communicating with the UE to continue and complete the CFRA procedure initiated by the UE.

In one example aspect of the invention there is provided a method performed by a user equipment (UE) for gaining access to a communication network, the method including: receiving, from apparatus for providing access to the communication network, system information including random-access configuration information for configuring the UE to perform random-access procedures, wherein the random-access configuration information includes a plurality of different respective physical random-access (PRACH) preamble formats that can be applied by the UE in a random-access procedure; identifying, from the plurality of different PRACH preamble formats, a PRACH preamble format to be used for a random-access procedure, and selecting a random-access preamble based on the identified PRACH preamble format; transmitting, to the apparatus for providing access to the communication network, signalling for initiating a random-access procedure, the signalling including a random-access preamble having a one of the plurality of different PRACH preamble formats; and communicating with the apparatus for providing access to the communication network to continue and complete the random-access procedure initiated by the UE.

In one example aspect of the invention there is provided apparatus for providing access to a communication network, the apparatus including: a controller and a transceiver the controller being configured to: control the transceiver to transmit to at least one user equipment (UE) system information including random-access configuration information for configuring the UE to perform random-access procedures, wherein the random-access configuration information includes a plurality of different physical random-access (PRACH) preamble formats that can be applied by the UE in a random-access procedure; control the transceiver to receive from the UE signalling for initiating a random-access procedure, the signalling including a random-access preamble having a one of the plurality of different PRACH preamble formats; and control the transceiver to communicate with the UE to continue and complete the random-access procedure initiated by the UE.

In one example aspect of the invention there is provided apparatus for providing access to a communication network, the apparatus including: a controller and a transceiver the controller being configured to: identify that a user equipment (UE) served by the apparatus is to perform a contention-free random-access (CFRA) procedure; select, from a plurality of possible physical random-access channel (PRACH) preamble formats, a PRACH preamble format to be used by the UE in the CFRA procedure, wherein the PRACH preamble format is selected based on a PRACH preamble format previously used by the UE in a random-access procedure; control the transceiver to signal, to the UE, a random-access preamble to be used in the CFRA procedure based on the selected PRACH preamble format; control the transceiver to receive from the UE signalling for initiating the CFRA procedure, the signalling including the signalled random-access preamble; and control the transceiver to communicate with the UE to continue and complete the CFRA procedure initiated by the UE.

In one example aspect of the invention there is provided a user equipment (UE) for a communication network, the UE including: a controller and a transceiver the controller being configured to: control the transceiver to receive, from apparatus for providing access to the communication network, system information including random-access configuration information for configuring the UE to perform random-access procedures, wherein the random-access configuration information includes a plurality of different respective physical random-access (PRACH) preamble formats that can be applied by the UE in a random-access procedure; identify, from the plurality of different PRACH preamble formats, a PRACH preamble format to be used for a random-access procedure, and selecting a random-access preamble based on the identified PRACH preamble format; control the transceiver to transmit, to the apparatus for providing access to the communication network, signalling for initiating a random-access procedure, the signalling including a random-access preamble having a one of the plurality of different PRACH preamble formats; and control the transceiver to transmit communicate with the apparatus for providing access to the communication network to continue and complete the random-access procedure initiated by the UE.

Example aspects of the invention extend to corresponding systems, apparatus, and computer program products such as computer readable storage media having instructions stored thereon which are operable to program a programmable processor to carry out a method as described in the example aspects and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently of (or in combination with) any other disclosed and/or illustrated features where it is technically feasible to do so. In particular but without limitation the features of any of the claims dependent from a particular independent claim may be introduced into that independent claim in any combination or individually wherever doing so does not cause a technically incompatibility or result in something that does not make technical sense.

### BRIEF DESCRIPTION OF DRAWINGS

Example embodiments of the invention will now be described, by way of example, with reference to the accompanying drawings in which:

FIG. 1 illustrates schematically different preamble formats that may be used for long preambles;

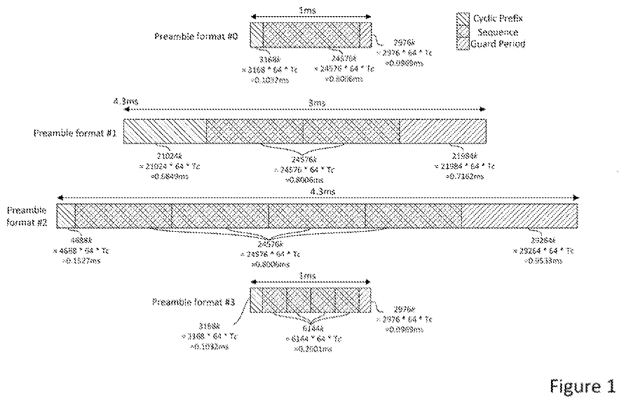

FIG. 2 illustrates schematically a mobile (cellular or wireless) telecommunication system to which example embodiments of the invention may be applied;

FIG. 3A illustrates a possible implementation of an access network that may be used in the system of FIG. 2;

FIG. 3B illustrates a possible implementation of an access network that may be used in the system of FIG. 2;

FIG. 3C illustrates a possible implementation of an access network that may be used in the system of FIG. 2;

FIG. 4 is a simplified block schematic illustrating the main components of a user equipment that may be used in the system of FIG. 2;

FIG. 5 is a simplified block schematic illustrating the main components of a base station that may be used in the system of FIG. 2;

FIG. 6 is a simplified block schematic illustrating the main components of a base station of a distributed type that may be used in the system of FIG. 2;

FIG. 7 is a simplified flow diagram illustrating a procedure for performing a flexible random-access procedure that may be used in the system of FIG. 2;

FIG. 8 is a simplified flow diagram illustrating a procedure for performing a flexible contention free random-access procedure that may be used in the system of FIG. 2;

FIG. 9 illustrates a respective way in which random-access channel configurations may be signalled in the system of FIG. 2;

FIG. 10 illustrates a respective way in which random-access channel configurations may be signalled in the system of FIG. 2; and

FIG. 11 illustrates a respective way in which random-access channel configurations may be signalled in the system of FIG. 2.

### DESCRIPTION OF EMBODIMENTS

Overview

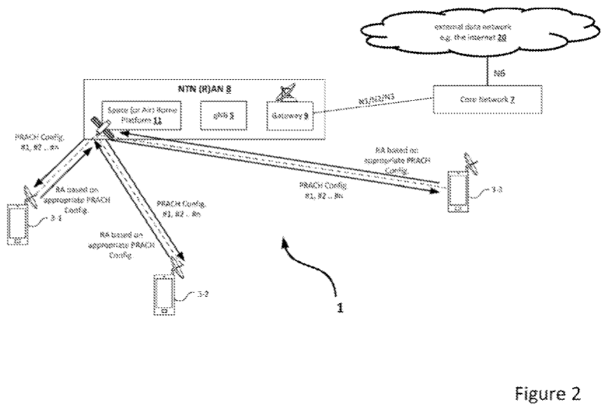

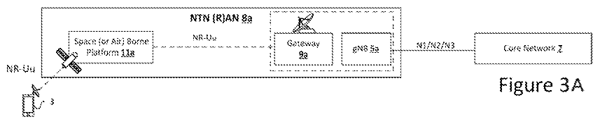

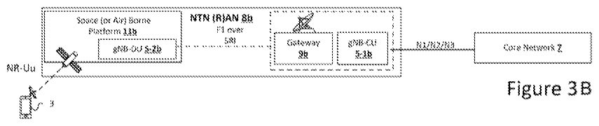

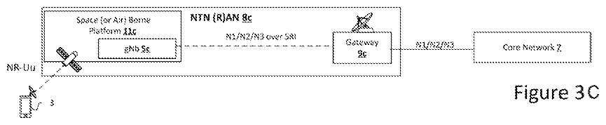

Referring to FIGS. 2 and 3, FIG. 2 illustrates schematically a mobile (cellular or wireless) communication system 1 to which example embodiments of the invention may be applied and FIGS. 3A to 3C each respectively illustrate a possible implementation of an access network 8 that may be used in the system of FIG. 2.

In this system 1, users of items of user equipment (UEs) 3-1, 3-2, 3-3 (e.g. mobile telephones and/or other mobile devices) can communicate with each other and/or other user equipment via an non-terrestrial network (NTN) radio access network (RAN) 8 that operates according to one or more compatible radio access technologies (RATs) for example, an E-UTRA and/or 5G RAT. In the illustrated example, the NTN RAN includes a base station or ‘gNB’ 5 operating one or more associated cells, a gateway 9, and a non-terrestrial (space or air borne) platform 11 (e.g. including one or more satellites and/or airborne vehicles). Communication via the NTN RAN 8 is typically routed through a core network 7 (e.g. a 5G core network or evolved packet core network (EPC)) and one or more external data networks 20 (e.g. via an N6 interface/reference point or the like).

As those skilled in the art will appreciate, whilst three UEs 3 and one NTN RAN 8 including one base station 5, on one gateway and one non-terrestrial platform 11 are shown in FIG. 2 for illustration purposes, the system, when implemented, will typically include any number of UEs, other RANs (both terrestrial and non-terrestrial), NTN platforms, base stations, gateways, UEs etc.

As seen in FIGS. 3A to 3C the NTN RAN 8 may be implemented in a number of different ways.

For example, as seen in FIG. 3A, the base station 5 may include a terrestrially located base station 5a that sends and receives communications respectively destined for and originating from the UEs (3) via a terrestrially located gateway 9a and via a non-terrestrial platform 11a that has no base station functionality. The non-terrestrial platform 11a relays these communications to and from the UEs 3 in the cell(s) operated by the base station 5a, and from and to the gateway 9a as required. The non-terrestrial platform 11a relays these communications transparently without on-board processing them in effect acting as a so-called ‘bent-pipe’. In this implementation, the feeder link between the gateway 9a and the non-terrestrial platform 11a effectively acts as part of the NR-Uu interface (or reference point) between the base station 5a and the UE(s) 3. Similarly, the service link between the non-terrestrial platform 11a and the UE(s) 3 effectively acts as another part of the NR-Uu interface (or reference point) between the base station 5a and the UE(s) 3. The base station's communication link with the core network 7 (e.g. for signalling over the N1, N2, N3 interface/reference point etc.) is provided solely terrestrially.

As seen in FIG. 3B the base station 5 may, for example, include a base station 5b of a distributed type having a terrestrially located central unit (CU) 5-1b and a distributed unit (DU) 5-2b provided on-board the non-terrestrial platform 11b. The terrestrially located CU 5-1b performs some of the (typically higher layer) functionality of the base station 5b whereas the non-terrestrially located DU 5-2b performs other (typically lower layer) functionality of the base station 5b. The terrestrially located CU 5-1b communicates with the non-terrestrially located DU 5-2b via the gateway 9b and an F1 interface implemented via a satellite radio interface between the gateway 9b and the non-terrestrial platform 11b in which the DU 5-2b is provided.

The non-terrestrial platform 11b transmits communications destined for and originating from the UEs (3) in the cell(s) operated by the base station 5b, and from and to the gateway 9a as required. However, in this implementation lower layer processing of communication respectively destined for and originating from the UEs (3) is performed on-board the non-terrestrial platform 11b by the DU 5-2b and higher layer processing of that communication respectively destined for and originating from the UEs (3) is performed by the terrestrially located CU 5-1b.

Accordingly, in this implementation, the feeder link between the gateway 9b and the non-terrestrial platform 11b effectively acts as the F1 interface (or reference point) between the CU and DU of the base station 5b. The service link between the non-terrestrial platform 11b and the UE(s) 3, on the other hand, effectively acts as the NR-Uu interface (or reference point) between the base station 5b and the UE(s) 3. The base station's communication link with the core network 7 (e.g. for signalling over the N1, N2, N3 interface/reference point etc.) is provided solely terrestrially.

As seen in FIG. 3C the base station 5 may, for example, include a base station 5c provided on-board the non-terrestrial platform 11c. The base station 5c on board the non-terrestrial platform 11c transmits communications destined for and originating from the UEs (3) in the cell(s) operated by the base station 5c, and from and to the core network 7 via the gateway 9c as required. However, in this implementation, processing of communication respectively destined for and originating from the UEs (3) is performed on-board the non-terrestrial platform 11c by the base station 5c.

Accordingly, in this implementation, the feeder link between the gateway 9c and the non-terrestrial platform 11b effectively acts as part of the N1/N2/N3 interfaces (or reference points) between the base station 5c and the core network 7. The base station's communication link with the core network 7 (e.g. for signalling over the N1, N2, N3 interface/reference point etc.) is thus provided partly via the feeder link and partly terrestrially. The service link between the non-terrestrial platform 11c and the UE(s) 3, on the other hand, effectively acts as the NR-Uu interface (or reference point) between the base station 5c and the UE(s) 3.

The base station 5 thus controls one or more associated cell(s) via the non-terrestrial platform 11. It will be appreciated that the base station 5 may be configured to support both 4G and 5G, and/or any other 3GPP or non-3GPP communication protocols.

The UE(s) 3 and the base station 5 are mutually configured for performing both contention based random access (RA) procedures and contention free RA (CFRA) procedures (e.g. as described in the introduction). For example, an appropriate contention-based or contention free RA procedure may be used to gain initial access to a cell, to re-establish a communication link (e.g. an RRC connection), during a handover procedure, to communicate downlink data that has arrived at the base station to the UE, for the purposes of addition of an NR cell for a non-standalone (NSA) implementation where the base station instructs the UE to initiate an RA procedure through a physical downlink control channel (PDCCH) carrying an allocated preamble, etc.

Beneficially, the system 1 allows different types of RA resources to be used for different UEs, by providing support for multiple preamble formats within a given cell (and per bandwidth part (BWP)). Specifically, unlike legacy systems in which the base station could only signal a single random access channel (RACH) configuration in a cell and hence single preamble format could be used (per BWP), the base station 5 in the system 1 is able to signal multiple different PRACH configurations having associated different PRACH preamble formats to the UE 3 in a single cell (per BWP). This allows any of the multiple different PRACH configurations and the associated PRACH preamble formats to be used by a given UE 3 and hence also allows different UEs 3 to use a different PRACH configurations and hence different PRACH preamble formats at the same time.

Moreover the UEs may beneficially be notified (either implicitly or explicitly) which PRACH resources to use, based on a characteristic or capability of that UE—for example based on that UE's timing advance pre-compensation capability (i.e. a capability of the UE to determine and apply appropriate UE specific compensation for a potential timing misalignment when performing a random-access procedure) and/or accuracy (as opposed to simply the UE's GNSS capability).

The UEs 3 in the cell are effectively grouped into a number of groups based on shared characteristics or capabilities that effect the likelihood of that those UEs will exhibit a large timing misalignment when performing a random-access procedure. Different PRACH configurations can thus be used by UEs in different respective groupings to achieve an optimal PRACH configuration (i.e. preamble format and number of Cyclic Shifts) for those UEs.

For example, the UEs 3 may be effectively grouped (or ‘classed’) based on their ability or inability to perform pre-compensation by calculating and pre-emptively applying an appropriate timing advance to compensate for any misalignment in advance (e.g. based on knowledge of their position and that of the base station). This is likely to be more effective than grouping based, for example, purely on the UE's GNSS capabilities which may not represent an accurate indication of pre-compensation capabilities.

Whilst having just two groups (e.g. one group for GNSS capable UEs with a pre-compensation capability and one group for other UEs with no UE specific timing advance pre-compensation capability) is beneficial, additional groups can be employed in the system 1 to provide further benefits. Two to four different groups has the potential to provide significant benefits. It will, nevertheless, be appreciated that any number of groups may be defined, and the number of groups need not be fixed but can be flexible, for example decided by the base station depending on context.

For example, additional UE groupings may include: a group for UEs with fast changing timing advance values—e.g. a group for high mobility UEs (indicating a relatively high likelihood of misalignment), a group for UEs with low GNSS coverage (indicating a relatively high likelihood of misalignment), and/or a group for low mobility UEs with stored TAs (indicating a relatively low likelihood of misalignment despite not necessarily having UE specific timing advance pre-compensation capabilities).

Moreover, additional groupings or sub-groupings could be based on positioning accuracy thresholds (e.g. 1 km, 50 km, no positioning) thereby providing additional benefits in terms of identifying an optimal PRACH preamble format.

On receipt of the multiple PRACH configurations from the base station 5, the UE 3 is able to identify an optimal PRACH preamble format for its own use based on the grouping(s) (or ‘class(es)’) in which that UE 3 falls.

In one possible example described in more detail later, the UE 3 identifies the different groupings implicitly based on the multiple PRACH configurations signalled by the base station 5. Specifically, broadcasting multiple PRACH configurations lets the UEs 3 know that there are different positioning accuracy levels and the preamble format of each broadcast PRACH configuration (which would have implicitly defined a cell radius in legacy systems) implicitly defines an associated positioning accuracy level that is required to be able to use that configuration.

In another possible example, an association between each UE grouping and the respective PRACH configuration is explicitly signalled from the base station to the UE 3. This association may be based, for example, a slice grouping, a UE Access identity, a new class of UEs etc.

It can be seen, therefore, that in the above system different PRACH preamble formats can be used to separate RACH resources. Ending the one-size-fits-all PRACH configuration approach beneficially allows UEs with pre-compensation capabilities (or with a low likelihood of a large timing misalignment) to access more RA resources. Given the expected number of UEs and cell size constraints of NTN, this has the potential to allow NTN base stations to serve UEs with poor or no positioning capabilities.

Various apparatus that may be used for implementing the system 1 will now be described, by way of example only.

User Equipment

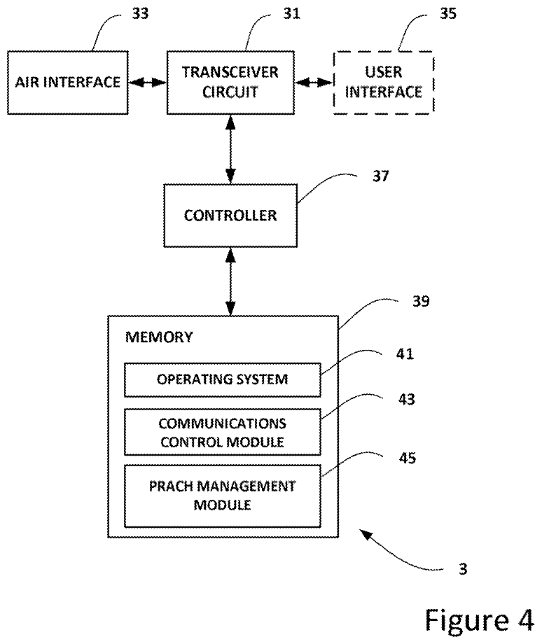

FIG. 4 is a simplified block schematic illustrating the main components of a UE 3 for implementation in the system of FIG. 2.

As shown, the UE 3 includes transceiver circuitry 31 that is operable to transmit signals to and to receive signals from a base station 5 via an air interface 33 and one or more antennas (e.g. indirectly via a non-terrestrial platform 11 and possibly gateway 9 where applicable or directly in a wholly terrestrial scenario).

The UE 3 has a controller 37 to control the operation of the UE 3. The controller 37 is associated with a memory 39 and is coupled to the transceiver circuit 31. Although not necessarily required for its operation, the UE 3 might, of course, have all the usual functionality of a conventional UE 3 (e.g. a user interface 35, such as a touch screen/keypad/microphone/speaker and/or the like for, allowing direct control by and interaction with a user) and this may be provided by any one or any combination of hardware, software and firmware, as appropriate.

The controller 37 is configured to control overall operation of the UE 3 by, in this example, program instructions or software instructions stored within the memory 39. The software may be pre-installed in the memory 39 and/or may be downloaded via the telecommunications network or from a removable data storage device (RMD), for example. As shown, these software instructions include, among other things, an operating system 41, a communications control module 43, and a PRACH management module 55.

The communications control module 43 is operable to control the communication between the UE 3 and the base station 5. For example, the communications control module 43 controls the part played by the UE 3 in the flow of uplink and downlink user traffic and of control data to be transmitted from the base station 5 including, for example, control data for managing operation of the UE 3. The communication control module 43 is responsible, for example, for controlling the part played by the UE 3 in procedures such as the reception of measurement control/configuration information, reception of system information, handover procedures, implementing appropriate timing advances to compensate for timing misalignments etc.

The PRACH management module 45 manages the performance of PRACH procedures such as the contention-based or contention free RA procedures at the UE side. This includes, for example: identifying available PRACH configurations from received system information; identifying appropriate preambles and/or cyclic shifts to use for RA procedures; the reception of signalling assigning a PRACH preamble to a UE (for contention free procedures); the transmission of RA messages to the base station (e.g. Msg1 carrying the preamble and/or Msg3); the processing and reception of RA messages from the base station (e.g. RA response messages (Msg2) and/or Msg4); and/or the reception and transmission of any other PRACH related signalling.

Base Station (Non-Distributed Type)

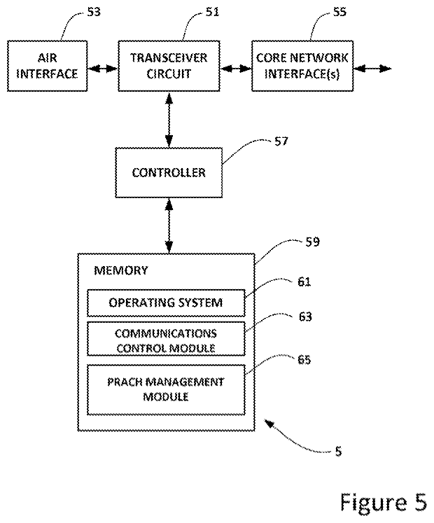

FIG. 5 is a simplified block schematic illustrating the main components of a base station 5 including a non-distributed type base station for implementation in the system of FIG. 2 (e.g. in an NTN access network 8 such as RAN 8a FIG. 3A or RAN 8c FIG. 3C or in a wholly terrestrial RAN).

As shown, the base station 5 includes transceiver circuitry 51 that is operable to transmit signals to and to receive signals from UEs 3 via an air interface 53 and one or more antennas (e.g. of the gateway 9 or non-terrestrial platform 11). The transceiver circuitry 51 is also operable to transmit signals to and to receive signals from functions of the core network 7 and/or other base stations 5 via a network interface 55. The network interface typically includes an N1, N2 and/or N3 interfaces for communicating with the core network and a base station to base station (e.g. Xn) interface for communicating with other base stations.

The base station 5 also includes a controller 57 which controls the operation of the transceiver circuitry 51 in accordance with software stored in memory 59. The software may be pre-installed in the memory 59 and/or may be downloaded via the communications network 1 or from a removable data storage device (RMD), for example. The software includes, among other things, a respective operating system 61 a communications control module 63, and a PRACH management module 65.

The communications control module 63 is operable to control the communication between the base station 5 and the UEs 3 and between the base station 5 and other network entities that are connected to the base station 5. For example, the communications control module 63 controls the part played by the base station 5 in the flow of uplink and downlink user traffic and of control data to be transmitted to the UE(s) 3 served by the base station 5 including, for example, control data for managing operation of the UEs 3. The communication control module 63 is responsible, for example, for controlling the part played by the base station in procedures such as the communication of measurement control/configuration information, the broadcast of system information, handover procedures, determining and signalling appropriate timing advances to compensate for timing misalignments etc.

The PRACH management module 65 manages the configuration of the various different PRACH configurations for different groups of UEs and for generating the corresponding configuration information for configuring those PRACH configurations (e.g. for provision in system information communicated under the overall control of the communication control module 63). The PRACH management module 65 also manages the performance of PRACH procedures such as the contention-based or contention free RA procedures at the base station side. This includes, for example: the assignment and signalling of a PRACH preamble to a UE (for contention free procedures); the reception and processing of RA messages from the UE (e.g. Msg1 carrying the preamble and/or Msg3); the transmission of RA messages to the UE (e.g. RA response messages (Msg2) and/or Msg4); and/or for managing the reception and transmission of any other PRACH related signalling.

Base Station (Distributed Type)

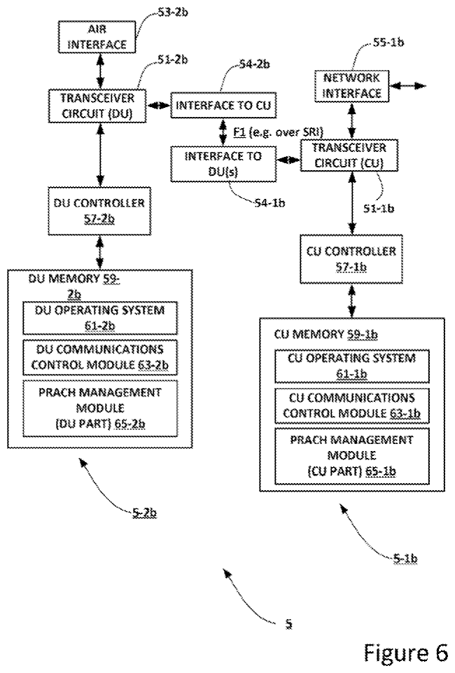

FIG. 6 is a simplified block schematic illustrating the main components of a base station 5 including a distributed type base station for implementation in the system of FIG. 2 (e.g. in an NTN access network 8 such as RAN 8b in FIG. 3B or in a wholly terrestrial RAN).

As shown, the base station 5 includes a distributed unit 5-1b and a central unit 5-2b. Each unit 5-1b, 5-2b includes respective transceiver circuitry 51-1b, 51-2b. The distributed unit 5-2b transceiver circuitry 51-2b is operable to transmit signals to and to receive signals from UEs 3 via an air interface 53-2b and one or more antennas (e.g. of the non-terrestrial platform 11 where the distributed unit of the base station 5-2b is onboard such a platform 11) and is also operable to transmit signals to and to receive signals from the central unit 5-1b via an interface 54-2b, for example the distributed unit side of an F1 interface (which may be provided over a satellite radio interface).

The central unit 5-1b transceiver circuitry 51-1b is operable to transmit signals to and to receive signals from functions of the core network 7 and/or other base stations 5 via a network interface 55-1b. The network interface typically includes an N1, N2 and/or N3 interfaces for communicating with the core network and a base station to base station (e.g. Xn) interface for communicating with other base stations. The central unit 5-1b transceiver circuitry 51-1b is also operable to transmit signals to and to receive signals from one or more distributed units 5-2b, for example the central unit side of an F1 interface provided, via the gateway 9b, over a satellite (or airborne platform) radio interface.

Each unit 5-1b, 5-2b includes a respective controller 57-1b, 57-2b which controls the operation of the corresponding transceiver circuitry 51-1b, 51-2b in accordance with software stored in the respective memories 59-1b and 59-2b of the distributed unit 5-2b and the central unit 5-1b. The software of each unit may be pre-installed in the memory 59-1b, 59-2b and/or may be downloaded via the communications network 1 or from a removable data storage device (RMD), for example. The software of each unit includes, among other things, a respective operating system 61-1b, 61-2b, a respective communications control module 63-1b, 63-2b, and a respective PRACH management module 65-1b, 65-2b.

Each communications control module 63-1b, 63-2b is operable to control the communication of its corresponding unit 5-1b, 5-2b including the communication from one unit to the other. The communications control module 63-2b of the distributed unit 5-2b controls communication between the distributed unit 5-2b and the UEs 3, and the communications control module 63-1b of the central unit 5-1b controls communication between the central unit 5-1b and other network entities that are connected to the distributed type base station 5b.

The communications control modules 63-1b, 63-2b also respectively control the part played by the distributed unit 5-2b and central unit 5-1b in the flow of uplink and downlink user traffic and control data to be transmitted to the communications devices served by the base station 5b including, for example, control data for managing operation of the UEs 3. Each communication control module 63-1b, 63-2b is responsible, for example, for controlling the respective part played by the distributed unit 5-2a and central unit 5-2b in procedures such as the communication of measurement control/configuration information, the broadcast of system information, handover procedures, determining and signalling appropriate timing advances to compensate for timing misalignments etc.

The PRACH management modules 65-1b, 65-2b manage the configuration of the various different PRACH configurations for different groups of UEs and for generating the corresponding configuration information for configuring those PRACH configurations (e.g. for providing in system information communicated under the overall control of the communication control modules 63-1b, 63-2b). The PRACH management modules 65-1b, 65-2b also manage the performance of PRACH procedures such as the contention-based or contention free RA procedures at the base station side. This includes, for example: the assignment and signalling of a PRACH preamble to a UE (for contention free procedures); the reception and processing of RA messages from the UE (e.g. Msg1 carrying the preamble and/or Msg3); the transmission of RA messages to the UE (e.g. RA response messages (Msg2) and/or Msg4); and/or for managing the reception and transmission of any other PRACH related signalling.

Various methods that may be used in the system 1 will now be described, by way of example only.

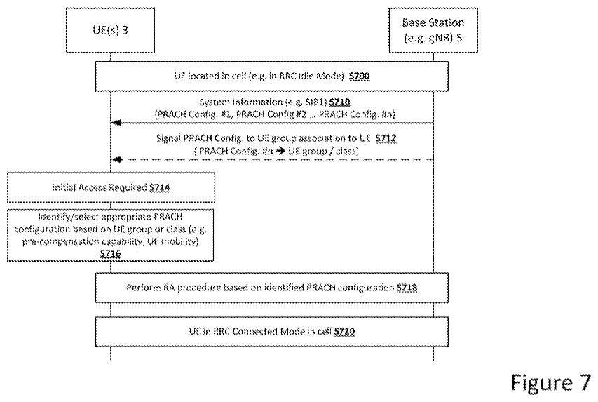

UE grouping based PRACH Configuration FIG. 7 is a simplified flow diagram illustrating a procedure for performing a flexible random-access procedure based on a PRACH configuration selected from multiple configured PRACH configurations.

The procedure starts at S700 when the UE 3 is located in a cell operated by the base station 5 (e.g. in an RRC Idle Mode). The UE 3 receives system information broadcast by the base station 5 at S710 (e.g. a system information block (SIB) such as SIB1). In this exemplary procedure, the system information includes information for configuring a plurality of different PRACH configurations for different groups of UEs, each group of UEs having a different shared characteristics and/or capability.

Where explicit signalling is used to identify the respective PRACH configuration (and hence the corresponding RA resources) associated with each UE group, the base station 5 may signal, at S712, information for identifying for a given PRACH configuration a corresponding group or class of UEs with which that PRACH configuration is associated. It will be appreciated that this may be signalled in any suitable way for example as part of a system information broadcast (including part of the SIB1 signalled as S710) or via any other signalling. It will be appreciated that where the association between PRACH configuration and UE groupings can be determined implicitly, this signalling may be omitted.

Each UE 3 in the cell receives the information identifying PRACH configurations and, when initial access is required at S714, the UE identifies (at S716) an appropriate PRACH configuration based on the UE group or class (or one of the UE groups or classes) in which the UE is located and selects a random-access preamble to use based on the PRACH preamble format represented by that PRACH configuration.

The UE 3 then initiates a random-access procedure with the base station 5 by sending the selected random-access preamble (e.g. in Msg1), and continues to perform the remaining random-access procedure, at S718. When that procedure is successfully completed enters and RRC connected mode at S720.

It will be appreciated that whilst the above procedure is described in the context of a random-access procedure performed for initial access, a similar procedure involving identification of a PRACH configuration from a number of possible configurations could be used in other contexts where a random-access procedure might be performed.

UE Dedicated Preamble Assignment Based on UE Grouping

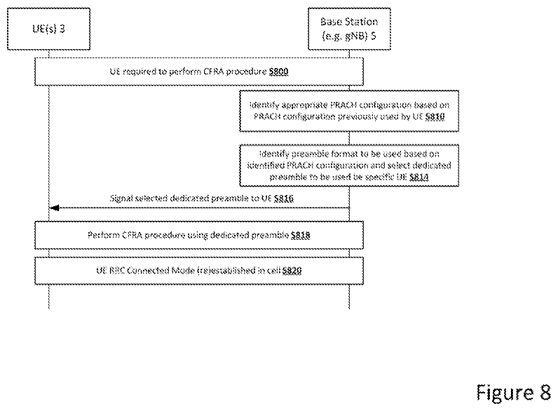

FIG. 8 is a simplified flow diagram illustrating a procedure for performing a flexible random-access procedure based on a PRACH configuration selected from multiple configured PRACH configurations as part of a contention free random access (CFRA) procedure.

This procedure may be performed, for example, as part of a handover procedure or other procedure in which the base station 5 assigns a UE dedicated preamble to a UE.

The procedure starts at S800 when the UE 3 is required to perform a CFRA procedure (e.g. during handover). The base station 5 identifies, at S810, an appropriate CFRA PRACH configuration for use by the UE based on a UE group that the UE 3 forms part of (e.g. a UE grouping based on the pre-compensation capabilities of the UE). The base station 5 may, for example, identify an appropriate CFRA PRACH configuration based on knowledge of the PRACH configuration previously chosen by the UE (e.g. during an earlier initial access procedure or the like), for example as indicated by the preamble format used previously used by that UE 3. The base station 5 thus identifies, at S814, the preamble format to be used based on the identified PRACH configuration, selects a preamble to be assigned as a dedicated preamble to the UE 3, and signals information for identifying the assigned preamble to the UE 3 at S816 (and other associated dedicated random access parameters).

The UE 3 receives the information identifying the preamble and initiates and performs a CFRA procedure with the base station 5 at S818, and when that procedure is successfully completed the RRC connected mode is (re)established at S820.

It can be seen that in this example, the number of UE groupings for CFRA procedures would be dependent on number of different CFRA PRACH configurations used for CFRA (which may be different to those available for contention based RA procedures) and each UE within a UE group will have a unique signature to send on the group's set of PRACH resources.

It will be appreciated that the signaling performed at S816 may include any suitable signalling message.

The signaling may, for example, be a unicast message carrying a rach-ConfigDedicated information element (IE), which is used for connection reconfiguration with synchronisation (e.g. handover).

For example, the message may include an RRCReconfiguration message, which is a command to modify an RRC connection. This message may convey information for measurement configuration, mobility control, radio resource configuration and access stratum security configuration. This message may include a CellGroupConfig IE, which is used to configure a master cell group (MCG) or secondary cell group (SCG). The CellGroupConfig IE may include the rach-ConfigDedicated IE that is used to specify the dedicated random-access parameters. On receipt of the configuration provided by the rach-ConfigDedicated IE, the UE 3 may perform the CFRA according to the these parameters in the first active uplink BWP as indicated by the firstActiveUplinkBWP IE which forms part of the uplink configuration indicated by the UplinkConfig IE in the ServingCellConfig IE (also forming part of the CellGroupConfig IE) part of the which is used to configure (add or modify) the UE with a serving cell, which may be the SpCell or an SCell of an MCG or SCG.

Signalling Multiple PRACH Configurations

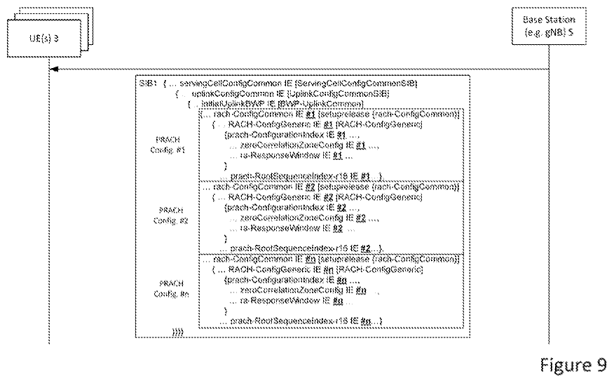

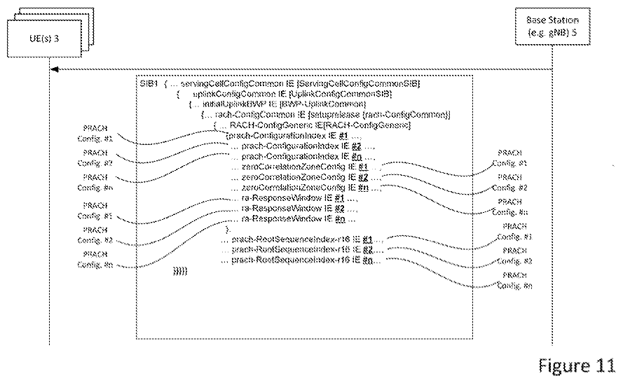

FIGS. 9 to 11 each illustrates a respective way in which the multiple PRACH configurations may be signalled by the base station 5 to the UE(s) 3 in a cell operated by the base station 5 (e.g. a cell of an NTN).

In each of these figures the different PRACH configurations are provided in a system information broadcast (SIB1). Specifically, the different PRACH configurations are provided using information elements (IEs) of an initialUplinkBWP IE/BWP-Uplink Common IE, of an uplinkConfigCommon IE/UplinkConfigCommonSIB IE, of servingCellConfigCommon IE/ServingCellConfigCommonSIB IE of SIB1.

SIB1 contains information relevant when evaluating if a UE is allowed to access a cell and defines the scheduling of other system information. It also contains radio resource configuration information that is common for all UEs and barring information applied to the unified access control.

The IE ServingCellConfigCommonSIB is used to configure cell specific parameters of a UE's serving cell in SIB1. The IE UplinkConfigCommonSIB provides common uplink parameters of a cell. The IE BWP-UplinkCommon is used to configure the common parameters of an uplink BWP. They are “cell specific” and the network ensures the necessary alignment with corresponding parameters of other UEs. The common parameters of the initial bandwidth part of a primary cell are also provided via system information. For all other serving cells, the network provides the common parameters via dedicated signalling.

The IE RACH-ConfigCommon is used to specify the cell specific random-access parameters for a given PRACH configuration. This IE includes, among other IEs, the RACH-ConfigGeneric IE and the prach-RootSequenceIndex-r16 IE. The IE RACH-ConfigGeneric is used to specify the random-access parameters both for regular random access as well as for beam failure recovery. The IE prach-RootSequenceIndex-r16 provides the PRACH root sequence index and has a value in the range 0 . . . 837 or 0 . . . 137 depending on whether the length of the sequence is 839 or 139).

The IE RACH-ConfigGeneric includes, among other IEs: the prach-Configurationindex IE that indicates the location and periodicity of RA resources; the ra-ResponseWindow IE that indicates the Msg2 (RAR) window length in number of slots and that will differ depending on UL TA misalignment; and the zeroCorrelationZoneConfig IE that provides the cyclic shift configuration.

In FIG. 9, a respective RACH-ConfigCommon IE is included in SIB1 for each PRACH configuration. For example, each RACH-ConfigCommon IE contains a version of at least the relevant IEs for defining a respective PRACH configurations (e.g. a respective RACH-ConfigGeneric IE and/or a respective prach-RootSequenceIndex-r16 IE for each PRACH configuration).

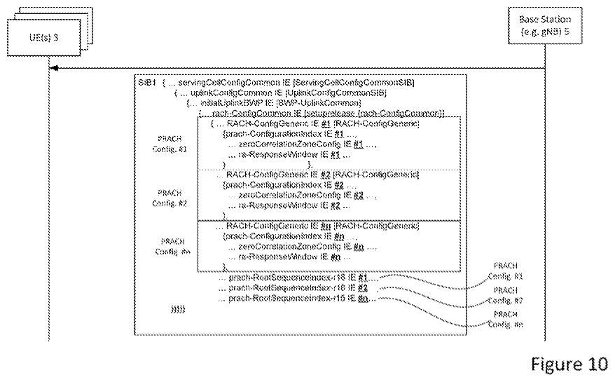

In FIG. 10, a single RACH-ConfigCommon IE is included in SIB1 but a respective instance of every relevant IE is included in the single RACH-ConfigCommon IE for each PRACH configuration. For example, the single RACH-ConfigCommon IE contains a respective version of at least the relevant IEs for defining each PRACH configuration (e.g. a respective RACH-ConfigGeneric IE and/or a respective prach-RootSequenceIndex-r16 IE for each PRACH configuration).

In FIG. 10, a single RACH-ConfigCommon IE and a single RACH-ConfigGeneric IE is included in SIB1 but a respective instance of every relevant IE for each PRACH configuration is also included in the single RACH-ConfigCommon IE and the single RACH-ConfigGeneric IE as appropriate for each PRACH configuration. For example, the single RACH-ConfigCommon IE contains, in addition to the single RACH-ConfigGeneric IE, a respective version of at least the relevant RACH-ConfigCommon IEs (e.g. a respective prach-RootSequenceIndex-r16 IE for each PRACH configuration). The single RACH-ConfigGeneric IE contained by the single RACH-ConfigCommon IE includes a respective version of at least the relevant RACH-ConfigGeneric IEs for defining each PRACH configuration (e.g. a respective prach-Configurationindex IE, a respective ra-ResponseWindow IE, and/or a respective zeroCorrelationZoneConfig IE for each PRACH configuration).

Modifications and Alternatives

A detailed example embodiment has been described above. As those skilled in the art will appreciate, a number of modifications and alternatives can be made to the above example embodiments whilst still benefiting from the inventions embodied therein.

It will be appreciated that description of features of and actions performed by a base station (or gNB) and UEs may be applied equally to base stations and UEs that communicate in the terrestrial plane only (i.e. as part of a terrestrial RAN without features of an NTN RAN such as a gateway and space or airborne platform) as to base stations that communicate via a non-terrestrial plane. Whilst terrestrial network cells do not (currently) broadcast their position and hence precise pre-compensation is not possible the features described can, nevertheless, have benefit (especially if pre-compensation in large terrestrial network cells is implemented in the future). For example, even where pre-compensation is not possible, a different PRACH configuration could be used for low mobility UEs that would remember their timing advance value (e.g. for large cell massive IoT) and thus have good timing alignment, than for other UEs. The provision of multiple PRACH configurations is therefore also applicable for massive machine-type-communication (mMTC) scenarios (e.g. sensors with high UE density in large cells requiring RACH for small UL transmissions from IDLE/INACTIVE), which are particularly demanding on the RACH.

Moreover, description of features of and actions performed by a base station (or gNB) apply equally to distributed type base stations as to non-distributed type base stations.

In the above description, the UEs and the base station are described for ease of understanding as having a number of discrete functional components or modules. In each of FIGS. 9 to 11, the different PRACH configurations are signalled using information elements of SIB1. It will be appreciated, however that the different PRACH configurations could be signalled using other signalling (e.g. a different system information block SIB than SIB1, a dedicated PRACH configuration message, or a modified message for some other purpose) using similar (or the same) information elements described for SIB1. It will also be appreciated whilst IEs having specific names have been described differently named IEs but having a similar purpose may be used.

Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied to the base station, to the mobility management entity, or to the UE as a signal over a computer network, or on a recording medium. Further, the functionality performed by part or all of this software may be performed using one or more dedicated hardware circuits. However, the use of software modules is preferred as it facilitates the updating of the base station or the UE in order to update their functionalities.

Each controller may include any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; moulds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may include automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine-type communication applications.

TABLE 2

| Service Area | MTC applications |
|---|---|
| Security | Surveillance systems |
| | Backup for landline |
| | Control of physical access (e.g. to |
| | buildings) |
| | Car/driver security |
| Tracking & Tracing | Fleet Management |
| | Order Management |
| | Pay as you drive |
| | Asset Tracking |
| | Navigation |
| | Traffic Information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Further, the above-described UE categories are merely examples of applications of the technical ideas and example embodiments described in the present document. Needless to say, these technical ideas and example embodiments are not limited to the above-described UE and various modifications can be made thereto.

It can be seen, in summary, that in one example described above there is described a method performed by apparatus for providing access to a communication network, the method including: transmitting to at least one user equipment (UE) system information including random-access configuration information for configuring the UE to perform random-access procedures, wherein the random-access configuration information includes a plurality of different physical random-access (PRACH) preamble formats that can be applied by the UE in a random-access procedure; receiving from the UE signalling for initiating a random-access procedure, the signalling including a random-access preamble having a one of the plurality of different PRACH preamble formats; and communicating with the UE to continue and complete the random-access procedure initiated by the UE.

Each of the plurality of different PRACH preamble formats represented by the random-access configuration information may be associated with a different respective possible characteristic or capability of the UE.

The method may include transmitting to the at least one UE information indicating which PRACH preamble format, of the plurality of different PRACH preamble formats represented by the random-access configuration information, is respectively associated with each possible characteristic or capability of the UE, wherein the preamble received from the UE has a PRACH preamble format associated with a characteristic or capability of that the UE has. The information indicating which PRACH preamble format may be respectively associated with each possible characteristic or capability of the UE may be transmitted with the random-access configuration information.

Each of at least two of the plurality of different PRACH preamble formats represented by the random-access configuration information may be associated with different respective possible pre-compensation capabilities of the UE. The different possible pre-compensation capabilities may include at least: a first pre-compensation capability for a UE that has a capability to perform pre-compensation; and second pre-compensation capability for a UE that does not have a capability to perform pre-compensation. Each of at least two of the different possible pre-compensation capabilities may represent a different respective possible accuracy with which the UE: can perform pre-compensation; and/or determine a position of the UE on which pre-compensation is to be based. At least one of the plurality of different PRACH preamble formats represented by the random-access configuration information is associated with a possible mobility characteristic of the UE. At least one of the plurality of different PRACH preamble formats represented by the random-access configuration information may be associated with a possible rate at which timing advance values for the UE are changing. At least one of the plurality of different PRACH preamble formats represented by the random-access configuration information may be associated with a possible Global Navigation Satellite System (GNSS) capability the UE. At least one of the plurality of different PRACH preamble formats represented by the random-access configuration information may be associated with a possible Global Navigation Satellite System (GNSS) coverage at the UE.

The system information including random-access configuration information may be transmitted using information elements (IEs) of a type 1 system information block (SIB1). The random-access configuration information may be transmitted using a different respective prach-RootSequenceIndex information element (IE) for each of the plurality of different PRACH preamble formats. The random-access configuration information may be transmitted using a different respective ra-ResponseWindow information element (IE) for each of the plurality of different PRACH preamble formats. The random-access configuration information may be transmitted using a different respective zeroCorrelationZoneConfig information element (IE) for each of the plurality of different RACH configurations.

The random-access configuration information may be transmitted using a different respective prach-ConfigurationIndex information element (IE) for each of the plurality of different PRACH preamble formats. The random-access channel (RACH) configuration information may be transmitted using a different respective RACH-ConfigGeneric information element (IE) for each of the plurality of different PRACH preamble formats. The random-access channel (RACH) configuration information may be transmitted using at least a different respective RACH-ConfigCommon information element (IE) for each of the plurality of different PRACH preamble formats.

In another example described above there is described a method performed by apparatus for providing access to a communication network, the method including: identifying that a user equipment (UE) served by the apparatus is to perform a contention-free random-access (CFRA) procedure; selecting, from a plurality of possible physical random-access channel (PRACH) preamble formats, a PRACH preamble format to be used by the UE in the CFRA procedure, wherein the PRACH preamble format is selected based on a PRACH preamble format previously used by the UE in a random-access procedure; signalling, to the UE, a random-access preamble to be used in the CFRA procedure based on the selected PRACH preamble format; receiving from the UE signalling for initiating the CFRA procedure, the signalling including the signalled random-access preamble; and communicating with the UE to continue and complete the CFRA procedure initiated by the UE.

The random-access preamble may be signalled to the UE using a rach-ConfigDedicated information element (IE). The method may be performed as part of a handover procedure.

In another example described above there is described a method performed by a user equipment (UE) for gaining access to a communication network, the method including: receiving, from apparatus for providing access to the communication network, system information including random-access configuration information for configuring the UE to perform random-access procedures, wherein the random-access configuration information includes a plurality of different respective physical random-access (PRACH) preamble formats that can be applied by the UE in a random-access procedure; identifying, from the plurality of different PRACH preamble formats, a PRACH preamble format to be used for a random-access procedure, and selecting a random-access preamble based on the identified PRACH preamble format; transmitting, to the apparatus for providing access to the communication network, signalling for initiating a random-access procedure, the signalling including a random-access preamble having a one of the plurality of different PRACH preamble formats; and communicating with the apparatus for providing access to the communication network to continue and complete the random-access procedure initiated by the UE.

In another example described above there is described apparatus for providing access to a communication network, the apparatus including: a controller and a transceiver the controller being configured to: control the transceiver to transmit to at least one user equipment (UE) system information including random-access configuration information for configuring the UE to perform random-access procedures, wherein the random-access configuration information includes a plurality of different physical random-access (PRACH) preamble formats that can be applied by the UE in a random-access procedure; control the transceiver to receive from the UE signalling for initiating a random-access procedure, the signalling including a random-access preamble having a one of the plurality of different PRACH preamble formats; and control the transceiver to communicate with the UE to continue and complete the random-access procedure initiated by the UE.

In another example described above there is described apparatus for providing access to a communication network, the apparatus including: a controller and a transceiver the controller being configured to: identify that a user equipment (UE) served by the apparatus is to perform a contention-free random-access (CFRA) procedure; select, from a plurality of possible physical random-access channel (PRACH) preamble formats, a PRACH preamble format to be used by the UE in the CFRA procedure, wherein the PRACH preamble format is selected based on a PRACH preamble format previously used by the UE in a random-access procedure; control the transceiver to signal, to the UE, a random-access preamble to be used in the CFRA procedure based on the selected PRACH preamble format; control the transceiver to receive from the UE signalling for initiating the CFRA procedure, the signalling including the signalled random-access preamble; and control the transceiver to communicate with the UE to continue and complete the CFRA procedure initiated by the UE.

In another example described above there is described a user equipment (UE) for a communication network, the UE including: a controller and a transceiver the controller being configured to: control the transceiver to receive, from apparatus for providing access to the communication network, system information including random-access configuration information for configuring the UE to perform random-access procedures, wherein the random-access configuration information includes a plurality of different respective physical random-access (PRACH) preamble formats that can be applied by the UE in a random-access procedure; identify, from the plurality of different PRACH preamble formats, a PRACH preamble format to be used for a random-access procedure, and selecting a random-access preamble based on the identified PRACH preamble format; control the transceiver to transmit, to the apparatus for providing access to the communication network, signalling for initiating a random-access procedure, the signalling including a random-access preamble having a one of the plurality of different PRACH preamble formats; and control the transceiver to transmit communicate with the apparatus for providing access to the communication network to continue and complete the random-access procedure initiated by the UE.

Example aspects of the invention extend to corresponding systems, apparatus, and computer program products such as computer readable storage media having instructions stored thereon which are operable to program a programmable processor to carry out a method as described in the example aspects and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently of (or in combination with) any other disclosed and/or illustrated features where it is technically feasible to do so. In particular but without limitation the features of any of the claims dependent from a particular independent claim may be introduced into that independent claim in any combination or individually wherever doing so does not cause a technically incompatibility or result in something that does not make technical sense.

Various other modifications will be apparent to those skilled in the art and will not be described in further detail here.

The whole or part of the example embodiments disclosed above can be described as, but not limited to, the following supplementary notes.

(Supplementary Note 1)

A method performed by apparatus for providing access to a communication network, the method including:
transmitting to at least one user equipment (UE) system information including random-access configuration information for configuring the UE to perform random-access procedures, wherein the random-access configuration information includes a plurality of different physical random-access (PRACH) preamble formats that can be applied by the UE in a random-access procedure;
receiving from the UE signalling for initiating a random-access procedure, the signalling including a random-access preamble having a one of the plurality of different PRACH formats; and
communicating with the UE to continue and complete the random-access procedure initiated by the UE.

(Supplementary Note 2)

A method according to supplementary note 1, wherein each of the plurality of different PRACH formats represented by the random-access configuration information is associated with a different respective possible characteristic or capability of the UE.

(Supplementary Note 3)

A method according to supplementary note 2, wherein the method further includes transmitting to the at least one UE information indicating which PRACH format, of the plurality of different PRACH formats represented by the random-access configuration information, is respectively associated with each possible characteristic or capability of the UE, and wherein the preamble received from the UE has a PRACH format associated with a characteristic or capability of that the UE has.

(Supplementary Note 4)

A method according to supplementary note 3, wherein the information indicating which PRACH format is respectively associated with each possible characteristic or capability of the UE is transmitted with the random-access configuration information.

(Supplementary Note 5)

A method according to any one of supplementary notes 2 to 3, wherein each of at least two of the plurality of different PRACH preamble formats represented by the random-access configuration information are associated with different respective possible pre-compensation capabilities of the UE.

(Supplementary Note 6)

A method according to supplementary note 5, wherein the different possible pre-compensation capabilities include at least: a first pre-compensation capability for a UE that has a capability to perform pre-compensation; and second pre-compensation capability for a UE that does not have a capability to perform pre-compensation.

(Supplementary Note 7)

A method according to supplementary note 5 or 6, wherein each of at least two of the different possible pre-compensation capabilities represents a different respective possible accuracy with which the UE: can perform pre-compensation; and/or determine a position of the UE on which pre-compensation is to be based.

(Supplementary Note 8)

A method according to any one of supplementary notes 5 to 7, wherein at least one of the plurality of different PRACH preamble formats represented by the random-access configuration information is associated with a possible mobility characteristic of the UE.

(Supplementary Note 9)

A method according to any one of supplementary notes 5 to 8, wherein at least one of the plurality of different PRACH preamble formats represented by the random-access configuration information is associated with a possible rate at which timing advance values for the UE are changing.

(Supplementary Note 10)

A method according to any one of supplementary notes 5 to 9, wherein at least one of the plurality of different PRACH preamble formats represented by the random-access configuration information is associated with a possible Global Navigation Satellite System (GNSS) capability the UE.

(Supplementary Note 11)

A method according to any one of supplementary notes 5 to 10, wherein at least one of the plurality of different PRACH preamble formats represented by the random-access configuration information is associated with a possible Global Navigation Satellite System (GNSS) coverage at the UE.

(Supplementary Note 12)

A method according to any one of supplementary notes 1 to 11, wherein the system information including random-access configuration information is transmitted using information elements (IEs) of a type 1 system information block (SIB1).

(Supplementary Note 13)

A method according to any one of supplementary notes 1 to 12, wherein the random-access configuration information is transmitted using a different respective prach-RootSequenceIndex information element (IE) for each of the plurality of different PRACH preamble formats.

(Supplementary Note 14)

A method according to any one of supplementary notes 1 to 13, wherein the random-access configuration information is transmitted using a different respective ra-ResponseWindow information element (IE) for each of the plurality of different PRACH preamble formats.

(Supplementary Note 15)

A method according to any one of supplementary notes 1 to 14, wherein the random-access configuration information is transmitted using a different respective zeroCorrelationZoneConfig information element (IE) for each of the plurality of different RACH configurations.

(Supplementary Note 16)

A method according to any one of supplementary notes 1 to 15, wherein the random-access configuration information is transmitted using a different respective prach-Configurationindex information element (IE) for each of the plurality of different PRACH preamble formats.

(Supplementary Note 17)

A method according to any one of supplementary notes 1 to 16, wherein the random-access channel (RACH) configuration information is transmitted using a different respective RACH-ConfigGeneric information element (IE) for each of the plurality of different PRACH preamble formats.

(Supplementary Note 18)

A method according to any one of supplementary notes 1 to 17, wherein the random-access channel (RACH) configuration information is transmitted using at least a different respective RACH-ConfigCommon information element (IE) for each of the plurality of different PRACH preamble formats.

(Supplementary Note 19)

A method performed by apparatus for providing access to a communication network, the method including:
identifying that a user equipment (UE) served by the apparatus is to perform a contention-free random-access (CFRA) procedure;
selecting, from a plurality of possible physical random-access channel (PRACH) formats, a PRACH preamble format to be used by the UE in the CFRA procedure, wherein the PRACH preamble format is selected based on a PRACH preamble format previously used by the UE in a random-access procedure;
signalling, to the UE, a random-access preamble to be used in the CFRA procedure based on the selected PRACH preamble format;
receiving from the UE signalling for initiating the CFRA procedure, the signalling including the signalled random-access preamble; and communicating with the UE to continue and complete the CFRA procedure initiated by the UE.

(Supplementary Note 20)

A method according to supplementary note 19, wherein the random-access preamble is signalled to the UE using a rach-ConfigDedicated information element (IE).

(Supplementary Note 21)

A method according to supplementary note 19 or 20, wherein the method is performed as part of a handover procedure.

(Supplementary Note 22)

A method performed by a user equipment (UE) for gaining access to a communication network, the method including:
receiving, from apparatus for providing access to the communication network, system information including random-access configuration information for configuring the UE to perform random-access procedures, wherein the random-access configuration information includes a plurality of different respective physical random-access (PRACH) preamble formats that can be applied by the UE in a random-access procedure;
identifying, from the plurality of different PRACH preamble formats, a PRACH preamble format to be used for a random-access procedure, and selecting a random-access preamble based on the identified PRACH preamble format;
transmitting, to the apparatus for providing access to the communication network, signalling for initiating a random-access procedure, the signalling including a random-access preamble having a one of the plurality of different PRACH preamble formats; and
communicating with the apparatus for providing access to the communication network to continue and complete the random-access procedure initiated by the UE.

(Supplementary Note 23)

Apparatus for providing access to a communication network, the apparatus including:
a controller and a transceiver the controller being configured to:
   control the transceiver to transmit to at least one user equipment (UE) system information including random-access configuration information for configuring the UE to perform random-access procedures, wherein the random-access configuration information includes a plurality of different physical random-access (PRACH) preamble formats that can be applied by the UE in a random-access procedure;
   control the transceiver to receive from the UE signalling for initiating a random-access procedure, the signalling including a random-access preamble having a one of the plurality of different PRACH preamble formats; and
   control the transceiver to communicate with the UE to continue and complete the random-access procedure initiated by the UE.

(Supplementary Note 24)

Apparatus for providing access to a communication network, the apparatus including:
a controller and a transceiver the controller being configured to:
   identify that a user equipment (UE) served by the apparatus is to perform a contention-free random-access (CFRA) procedure;
   select, from a plurality of possible physical random-access channel (PRACH) preamble formats, a PRACH preamble format to be used by the UE in the CFRA procedure, wherein the PRACH preamble format is selected based on a PRACH preamble format previously used by the UE in a random-access procedure;
   control the transceiver to signal, to the UE, a random-access preamble to be used in the CFRA procedure based on the selected PRACH preamble format;
   control the transceiver to receive from the UE signalling for initiating the CFRA procedure, the signalling including the signalled random-access preamble; and

control the transceiver to communicate with the UE to continue and complete the CFRA procedure initiated by the UE.

(Supplementary Note 25)

A user equipment (UE) for a communication network, the UE including:
a controller and a transceiver the controller being configured to:
   control the transceiver to receive, from apparatus for providing access to the communication network, system information including random-access configuration information for configuring the UE to perform random-access procedures, wherein the random-access configuration information includes a plurality of different respective physical random-access (PRACH) preamble formats that can be applied by the UE in a random-access procedure;
   identify, from the plurality of different PRACH preamble formats, a PRACH preamble format to be used for a random-access procedure, and selecting a random-access preamble based on the identified PRACH preamble format;
   control the transceiver to transmit, to the apparatus for providing access to the communication network, signalling for initiating a random-access procedure, the signalling including a random-access preamble having a one of the plurality of different PRACH preamble formats; and
   control the transceiver to transmit communicate with the apparatus for providing access to the communication network to continue and complete the random-access procedure initiated by the UE.

This application is based upon and claims the benefit of priority from United Kingdom Patent Application No. 2100488.2, filed on Jan. 14, 2021, the disclosure of which is incorporated herein in its entirety by reference.

What is claimed is:

1. A method performed by a network node, the method comprising:
transmitting, to a user equipment (UE), system information including random-access configuration information including a respective physical random-access channel (PRACH) preamble format per group of UEs;
receiving, from the UE, signalling for initiating a random-access procedure, the signalling including a random-access preamble having a PRACH preamble format corresponding to one of groups of UEs, the one of the groups of UEs corresponding to the UE; and
communicating with the UE to continue the random-access procedure.

2. The method according to claim 1, wherein the PRACH preamble format corresponding to the one of the groups of UEs is associated with a characteristic or capability of respective UEs corresponding to the one of the groups of UEs.

3. The method according to claim 2, further comprising:
transmitting, to the UE, first information indicating the PRACH preamble format corresponding to the one of the groups of UEs is associated with each characteristic or capability of the UE.

4. The method according to claim 3, wherein the first information is transmitted with the random-access configuration information.

5. The method according to claim 2, wherein each of at least two of the respective PRACH preamble format per group of UEs is associated with a respective pre-compensation capability of the UE.

6. The method according to claim 5, wherein each of the respective pre-compensation capability includes at least one of:
a first pre-compensation capability for a UE that has a capability to perform pre-compensation; and
a second pre-compensation capability for a UE that does not have a capability to perform pre-compensation.

7. The method according to claim 5, wherein each of at least two of the respective pre-compensation capability represents a respective accuracy with which the UE can:
perform pre-compensation; and/or
determine a position of the UE on which pre-compensation is to be based.

8. The method according to claim 5, wherein at least one of the respective PRACH preamble format per group of UEs is associated with at least one of:
a mobility characteristic of the UE,
a rate at which timing advance values for the UE are changing,
a Global Navigation Satellite System (GNSS) capability the UE, and
a Global Navigation Satellite System (GNSS) coverage at the UE.

9. The method according to claim 1, wherein the system information is transmitted using information elements (IEs) of a system information block type 1 (SIB1).

10. The method according to claim 1, wherein the random-access configuration information is transmitted using at least one of:
a respective prach-RootSequenceIndex information element (IE) for each of the plurality of PRACH preamble formats,
a respective ra-ResponseWindow information element (IE) for each of the plurality of PRACH preamble formats,
a respective zeroCorrelationZoneConfig information element (IE) for each of a plurality of random access channel (RACH) configurations,
a respective prach-ConfigurationIndex information element (IE) for each of the plurality of PRACH preamble formats,
a respective RACH-ConfigGeneric information element (IE) for each of the plurality of different PRACH preamble formats, and/or
a respective RACH-ConfigCommon information element (IE) for each of the plurality of PRACH preamble formats.

11. A method performed by a network node, the method comprising:
selecting, from a plurality of physical random-access channel (PRACH) preamble formats, a PRACH preamble format to be used by a user equipment (UE) in a contention free random-access (CFRA) procedure, wherein the PRACH preamble format is selected based on a PRACH preamble format previously used by the UE in a random-access procedure;
signalling, to the UE, a random-access preamble to be used in the CFRA procedure based on the PRACH preamble format;
receiving, from the UE, signalling for initiating the CFRA procedure, the signalling including the random-access preamble; and
communicating with the UE to continue the CFRA procedure.

12. The method according to claim 11, wherein the random-access preamble is signalled to the UE using a rach-ConfigDedicated information element (IE).

13. The method according to claim 11, wherein the method is performed as part of a handover procedure.

14. A method performed by a user equipment (UE), the method comprising:
receiving, from a network node, system information including random-access configuration information including a respective physical random-access channel (PRACH) preamble format per group of UEs;
selecting a random-access preamble based on a PRACH preamble format corresponding to one of the groups of UEs, the one of the groups of UEs corresponding to the UE;
transmitting, to the network node, signalling for initiating a random-access procedure, the signalling including the random-access preamble; and
communicating with the network node to continue the random-access procedure.

15. A network node comprising:
a controller and a transceiver, wherein the controller is configured to:
control the transceiver to transmit, to a user equipment (UE), system information including random-access configuration information including a respective physical random-access channel (PRACH) preamble format per group of UEs;
control the transceiver to receive, from the UE, signalling for initiating a random-access procedure, the signalling including a random-access preamble having a preamble format corresponding to one of groups of UEs, the one of the groups of UEs corresponding to the UE; and
control the transceiver to communicate with the UE to continue the random-access procedure.

16. A network node comprising:
a controller and a transceiver, wherein the controller is configured to:
select, from a plurality of possible physical random-access channel (PRACH) preamble formats, a PRACH preamble format to be used by a user equipment (UE) in a contention free random-access (CFRA) procedure, wherein the PRACH preamble format is selected based on a PRACH preamble format previously used by the UE in a random-access procedure;
control the transceiver to signal, to the UE, a random-access preamble to be used in the CFRA procedure based on the PRACH preamble format;
control the transceiver to receive, from the UE, signalling for initiating the CFRA procedure, the signalling including the random-access preamble; and
control the transceiver to communicate with the UE to continue the CFRA procedure.

17. A user equipment (UE) comprising:
a controller and a transceiver, wherein the controller is configured to:
control the transceiver to receive, from a network node, system information including random-access configuration information including a respective physical random-access channel (PRACH) preamble format per group of UEs;
select a random-access preamble based on a PRACH preamble format corresponding to one of the groups of UEs, the one of the groups of UEs corresponding to the UE;
control the transceiver to transmit, to the network node, signalling for initiating a random-access procedure, the signalling including the random-access preamble; and
control the transceiver to transmit communicate with the network node to continue the random-access procedure.
